(19) United States
(12) Patent Application Publication
(10) Pub. No.: US 2006/0232080 A1
(43) Pub. Date: Oct. 19, 2006

(54) Handle housing

(76) Inventors: Matthew P. Washington, Geneva, IL (US); William G. Kozloski, Montgomery, IL (US); Charles E. Abens, Sandwich, IL (US)

Correspondence Address: SEYFARTH SHAW LLP, 131 S. DEARBORN ST., SUITE2400, CHICAGO, IL, 60603-5803, US

(21) Appl. No.: 11/105,206

(22) Filed: Apr. 13, 2005

(51) Int. Cl. E05B 9/00

(52) U.S. Cl. 292/337

(57) ABSTRACT

An embodiment of the present invention relates to handle housing for a door including a door opening and a slot adjacent thereto comprising a peripheral side wall extending from a bottom wall including an outer end defining an opening and an inner end extending through the door opening, a peripheral flange at the outer end, at least one finger at one end of the housing for insertion into the slot, and at least one upset on the peripheral side wall at the other end of the housing, in use the door being captured between the peripheral flange and the at least one upset.

### TECHNICAL FIELD

The present invention relates generally to lockers that are installed in schools, locker rooms, factories, convention centers, airports, train stations, bus terminals and the like, and specifically to the housing on the locker door which contains the latch mechanism.

### BACKGROUND

Storage lockers are generally utilized for the purpose of providing a relatively compact and safe place to temporarily store belongings. A conventional form of locker consists of a sheet metal frame and a hinged, latchable door. Typically, such storage lockers include a handle that latches and unlatches the door, with the handle accessible through a recessed handle housing mounted in the door. However, the handle housings of the prior art require fasteners in order to be attached or secured to the door. As a result, the prior art handle housings require more installation time and have additional components, such as fasteners and associated washers, which are also susceptible to loosening and wear.

### SUMMARY

There is disclosed herein an improved handle housing which includes improved assembly, attaching and securing features.

It is an object of the invention to provide a handle housing that is capable of being attached to a door without the need of fasteners.

Another object of the invention to provide a handle housing which is of very economical manufacture, yet is dependable in operation.

An illustrative embodiment of the present invention relates to handle housing for a door including a door opening and a slot adjacent thereto comprising a peripheral side wall extending from a bottom wall including an outer end defining an opening and an inner end extending through the door opening, a peripheral flange at the outer end, at least one finger at one end of the housing for insertion into the slot, and at least one upset on the peripheral side wall at the other end of the housing, in use the door being captured between the peripheral flange and the at least one upset.

Another illustrative embodiment of the present invention relates to a method for engaging a handle housing to a door including a door opening and a slot adjacent thereto, comprising inserting at least one finger of the handle housing into the slot in a first position to engage the slot with the at least one finger, rotating the handle housing from the first position to a second position, applying force to the handle housing sufficient to temporarily deform at least one upset on a peripheral side wall of the handle housing, and capturing the door between the upset and a peripheral flange on an outer end of the peripheral side wall.

A more detailed explanation of the invention is provided in the following description and claims and is illustrated in the accompanying drawings.

### BRIEF DESCRIPTION OF THE DRAWINGS

For the purpose of facilitating an understanding of the subject matter sought to be protected, there is illustrated in the accompanying drawings an embodiment thereof, from an inspection of which, when considered in connection with the following description, the subject matter sought to be protected, its construction and operation, and many of its advantages should be readily understood and appreciated.

FIG. 1 depicts a locker door incorporating the features of the handle housing of the present invention;

FIG. 2 is a perspective view of the handle housing with the latch mechanism partially fragmented;

FIG. 3 is a top view of the handle housing;

FIG. 4 is an exploded perspective view of the handle housing and the door;

FIG. 5 is a cross-sectional view of the engagement of the handle housing to the door, with the handle housing shown in a phantom position; and

FIG. 6 is a handle housing of the prior art.

### DETAILED DESCRIPTION

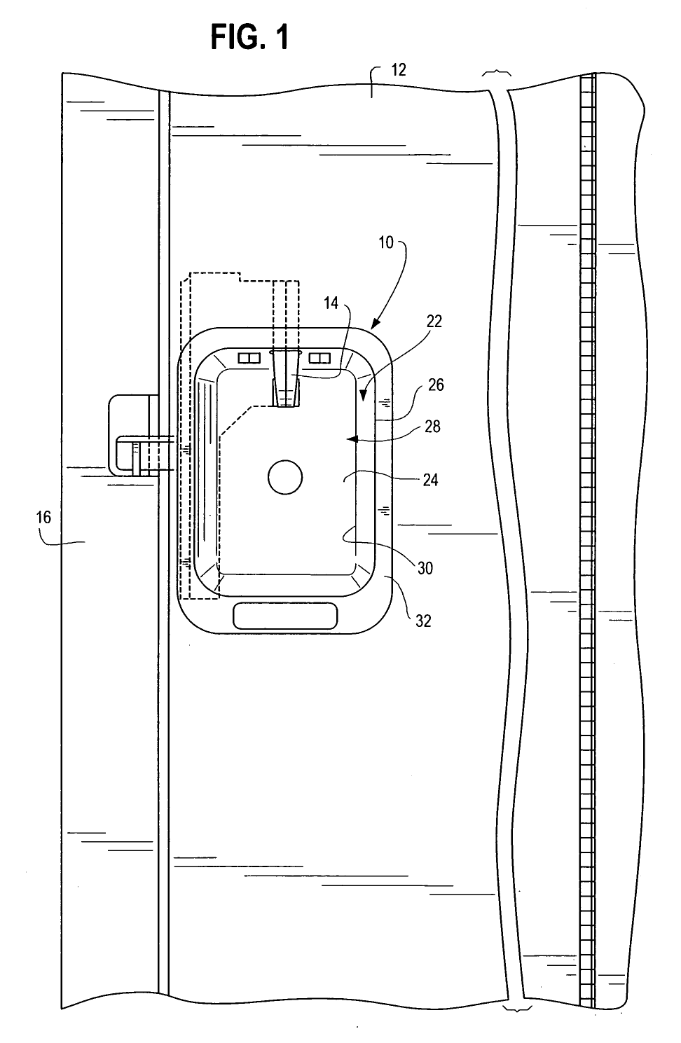

Referring to FIG. 1, there is depicted a handle housing 10 mounted in a locker door 12, and accommodating a latching handle 14 to provide latching engagement between the door 12 and a door frame 16. To that end, the handle housing 10 incorporating the features of the present invention is attached to the door 12 through a door opening 18 and a slot 20 adjacent thereto (shown in FIG. 4). The handle housing 10 includes a peripheral side wall 22 extending from a bottom wall 24. The peripheral side wall 22 includes an outer end 26 defining an opening 28 and an inner end 30 that extends through the door opening 18.

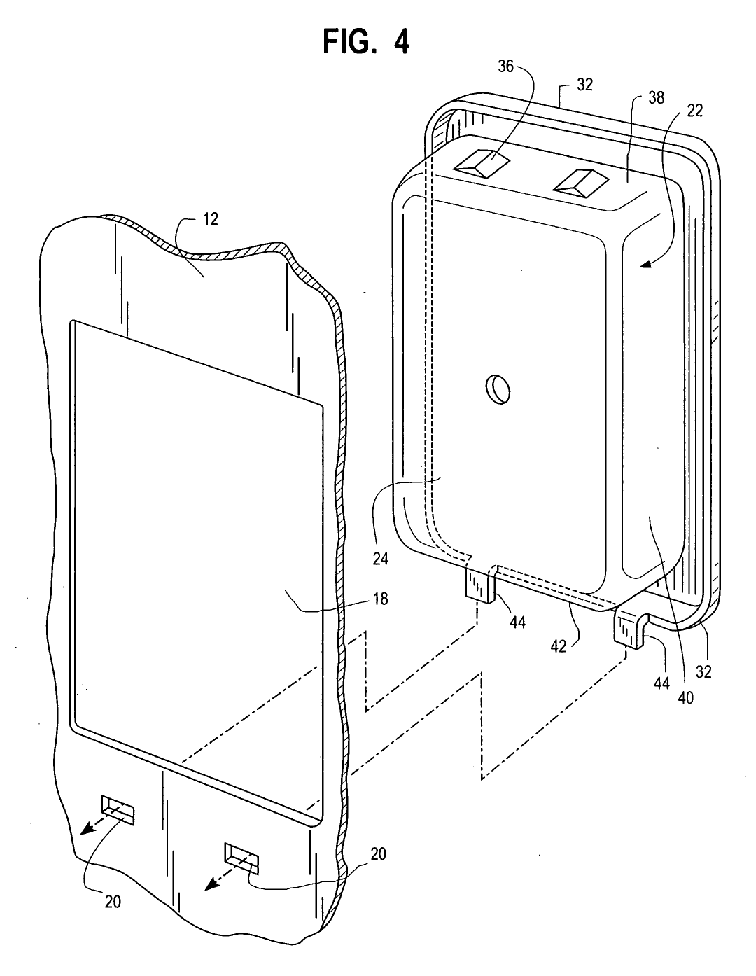

Referring to FIGS. 1 through 5, the side wall 22 also includes a peripheral flange 32 that is formed at the outer end 26. The side wall 22 and the bottom wall 24 cooperatively form a recessed area 33, with the handle 14 being movable within the recessed area 33 through an opening 34 in the side wall 22 that may, as depicted, further extend into the bottom wall 24. The opening 34 typically is cut or formed into side wall 22 and bottom wall 24 is configured to allow the latch handle 14 to be moved into and out of engagement with the door frame 16. The user may then operate the latch handle 14 by placing a finger into the recessed area 32 and engaging the latch handle 14 to unlatch the door 12 from the door frame 16, permitting access to the interior of the locker.

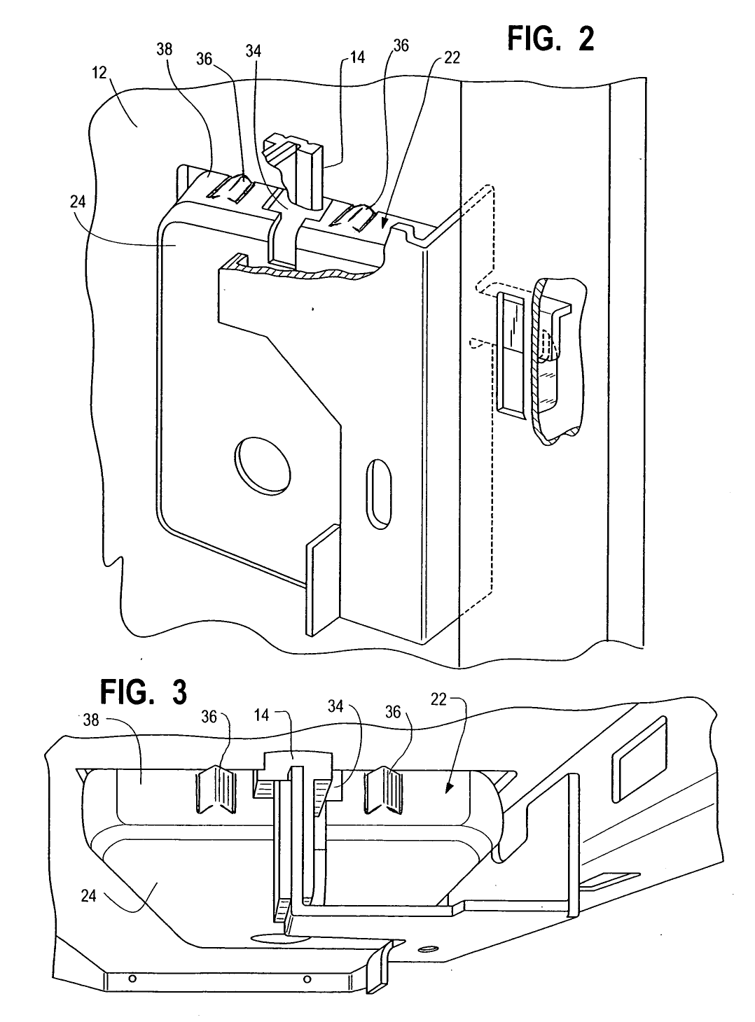

Referring now to FIGS. 2 through 5, the side wall 22 includes at least one upset 36 formed therein, which is raised above one end 38 of the housing 10. In the depicted embodiment, the housing has two upsets 36 formed on and raised above end 38. It is contemplated that the housing 10 may include additional upsets, including upsets on the sides 40 and other end 42 of the housing 10. The upsets 36 may be slightly resiliently deformable so as to facilitate installation of the housing 10 in door 12, as described below. In a preferred embodiment, the housing 10 is of unitary construction and stamped from aluminum.

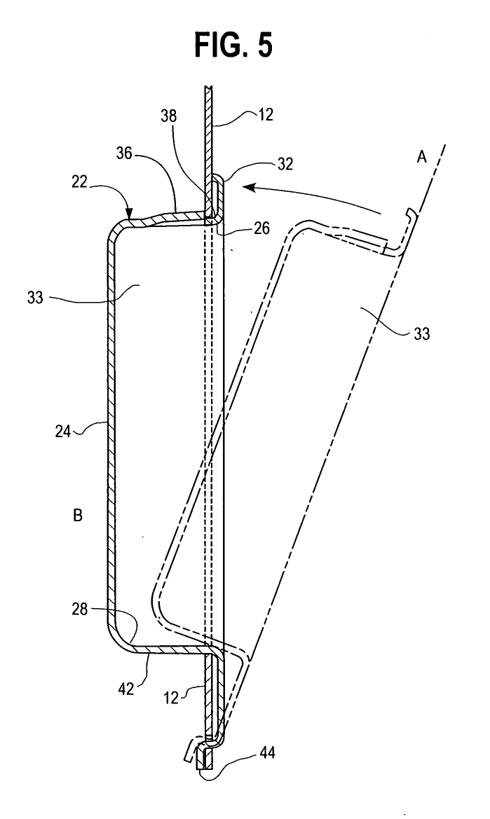

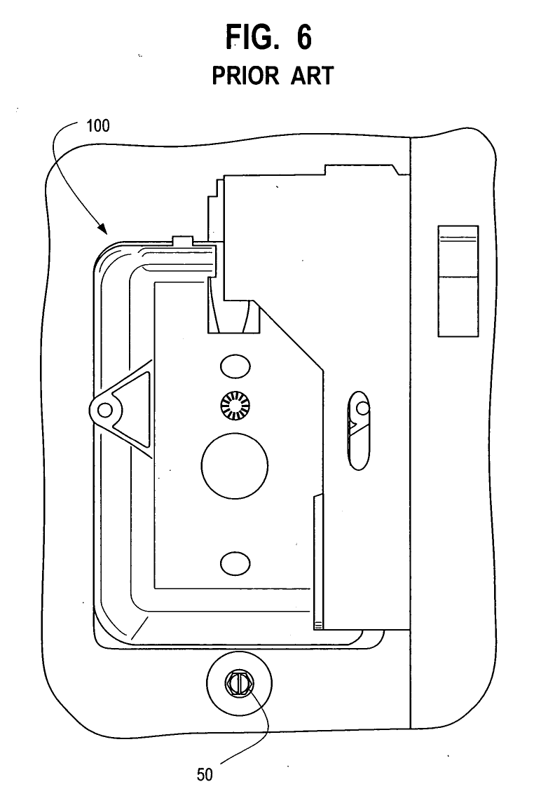

Referring to FIGS. 4 and 5, at least one finger 44 is located at the opposite end 42 of the housing 10 for insertion into slots 20 of the door 12. Preferably, the at least one finger 44 is located on and extends radially from peripheral flange 32. In the depicted embodiment, the housing has two fingers 44 formed on and extending radially from end 42. Further, it is contemplated that the housing 10 may include additional fingers, or may only have a single finger, for insertion into one or more slots 20 in door 12.

In the embodiment depicted in FIGS. 4 and 5, each finger 44 is generally L-shaped. The L-shaped configuration of fingers 44 allows the fingers 44 to be inserted into the slots 20 of the door 12 and hidden when viewing the door 12 from the outside. In operation, as detailed further below, the fingers 44 attach end 42 to the door 12, with the door 12 being captured between the upsets 36 and the peripheral flange 32 at the end 38.

In attaching housing 10 to the door 12, the fingers 44 are respectively aligned with slots 20 and inserted therein. Handle housing 10 is placed in a first position A, illustrated in FIG. 5. In this way, the fingers 44 cooperate with the door 12 to form a pivot location to allow the user rotate the handle housing 10 into position for installation. To install the handle housing 10, the user rotates the handle housing 10 from the first position A to a second position B, applying force to the handle housing 10 sufficient to move bottom wall 24 and inner end through door opening 18 and slightly deforming upsets 36 and/or door 12. Upon passage through the opening 18, door 12 is captured between the upsets 36 and the peripheral flange 32 on the outer end 26 of the peripheral side wall 22. As a result, the handle housing 10 is maintained in position with respect to door 12 by the combination of the capturing of the door 12 between the upsets 36 and the peripheral flange 32 and the fingers 44 inserted into slots 20 and outer end 26.

By capturing the door 12 between the upsets 36 and the peripheral flange 32, the handle housing 10 is prevented from moving substantially in direction perpendicular to the plane of the door 12. Similarly, the handle housing 10 is prevented from substantially traveling in a direction along the plane of the door 12 by fingers 44 and outer end 26. Thus, the attachment of the handle housing 10 to the door 12 is accomplished without fasteners, such as fasteners 50 of the prior art handle housing 100 depicted in FIG. 6.

Unlike the handle housing 10 of FIGS. 1-5, the prior art handle housing 100, as depicted in FIG. 6, utilizes at least one fastener to secure it to the door 12. As such, the handle housing 100 requires substantially more labor to affix to the door 12 than the handle housing 10 of the present invention. Furthermore, the fasteners may loosen, resulting in a poor fit between the handle housing 100 and the door 12. Thus, the handle housing 10 provides less complex, more reliable handle housing than those of the prior art.

A handle housing as detailed herein may be utilized in various forms. One such handle housing may be useful for simple installation, for purposes such as reducing installation time and components required for such installation. From the foregoing, it can be seen that there has been provided an improved mounting structure which greatly facilitates the adjustment thereof to user-determined locations.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

1. A handle housing for a door including a door opening and a slot adjacent thereto comprising:
a peripheral side wall extending from a bottom wall including an outer end defining an opening and an inner end extending through the door opening;
a peripheral flange at the outer end;
at least one finger extending from said flange at one end of the housing for insertion into the slot, the engagement of the finger and the slot forming a pivot location to allow the handle housing to be pivoted into engagement with the door; and
at least one upset on the peripheral side wall at an opposing end of the housing, in use the door being captured between the peripheral flange and the at least one upset when the handle housing is pivoted into engagement with the door.

2. The handle housing according to claim 1 being of unitary construction.

3. The handle housing according to claim 1, wherein the at least one finger is generally L-shaped.

4. The handle housing according to claim 1, wherein the at least one upset is resiliently deformable.

5. The handle housing according to claim 1, Wherein the at least one finger includes a second finger.

6. The handle housing according to claim 1, wherein the peripheral side wall includes a second upset thereon.

7. The handle housing according to claim 1, wherein the at least one finger extends from the flange.

8. A method for engaging a handle housing to a door including a door opening and a slot adjacent thereto, comprising the steps of:
inserting at least one finger extending from a peripheral flange connected to the handle housing into the slot in a first position to engage the slot with the at least one finger;
rotating the handle housing from the first position to a second position wherein the handle housing is in engagement with the door;
applying force to the handle housing sufficient to temporarily deform at least one upset at a second opposing end of a peripheral side wall of the handle housing; and
capturing the door between the upset and a peripheral flange on an outer end of the peripheral side wall.
